(19) United States
(12) Patent Application Publication
(10) Pub. No.: US 2026/0169770 A1
(43) Pub. Date: Jun. 18, 2026

(54) METHOD FOR DISPLAYING DESKTOP WINDOW, TERMINAL AND STORAGE MEDIUM

(71) Applicant: PAX COMPUTER TECHNOLOGY (SHENZHEN) CO., LTD., Shenzhen (CN)

(72) Inventors: Chuan LIU, Shenzhen (CN); Zhihai ZHENG, Shenzhen (CN)

(21) Appl. No.: 19/125,874

(22) PCT Filed: Jul. 27, 2023
(86) PCT No.: PCT/CN2023/109689

§ 371 Date: Apr. 30, 2025

(30) Foreign Application Priority Data
Nov. 15, 2022 (CN) 202211424559.8

(51) Int. Cl. G06F 9/451; G06F 3/0488; G06T 11/00

(52) U.S. Cl. CPC G06F 9/452; G06F 3/0488; G06T 11/00

(57) ABSTRACT

The present application is applicable to a display control technology field of computer, and provides a method for displaying desktop window, a device, a terminal and a storage medium. The method includes: obtaining a logic canvas associated with a plurality of applications, and the logic canvas being laid out with views to be displayed corresponding to the plurality of applications; according to setting display layer hierarchy list, mounting the logic canvas to a corresponding target display layer respectively; according to a hierarchical order of the target display layer on which the logical canvas is mounted in the setting display layer hierarchy list, obtain a view sequence by hierarchically sorting the logical canvas; sending a canvas synthesis instruction to a server for synthesizing and displaying the logical canvas. The present solution can realize display management and dynamic switching of desktop views, and meet interface application requirements.

This application claims priority to Chinese Patent Application No. 202211424559.8 filed on Nov. 15, 2022, entitled “method for displaying desktop window, device, terminal and storage medium”, in China National Intellectual Property Administration, the contents of which are incorporated by reference herein. cl FIELD

The present application belongs to a display control technology field of computer, and in particular, relates to a method for displaying desktop window, a terminal and a storage medium.

### BACKGROUND

As Android smartphones become more and more popular, people's experience with terminals is getting better and better. This is not only reflected in Android products. Other Linux and Real Time Operating System (RTOS) products are also gradually adding intelligent design, which is reflected in beautiful User Interface (UI), convenient human-computer interaction, and interconnection between devices.

Point Of Sale (POS) is usually based on a widely recognized open source operating system, such as traditional POS based on Linux operating system, and smart POS based on Android operating system. In domestic payment terminal market, Android POS dominates, but in the overseas payment market, Linux POS still accounts for a large proportion.

Linux POS is an embedded device and cannot run an open source X86-based desktop system. Existing open source Linux Graphical User Interface (GUI) frameworks do not support smart desktop management and dynamic switching of multiple application views similar to those in the Android system, making it difficult to support interface application requirements under desktop management and dynamic view switching.

### BRIEF DESCRIPTION OF THE DRAWINGS

In order to more clearly illustrate the technical solutions in the embodiments of the present application, the drawings required for use in the embodiments or the description of the prior art will be briefly introduced below. Obviously, the drawings described below are only some embodiments of the present application. For ordinary technicians in this field, other drawings can be obtained based on these drawings without paying any creative work.

FIG. 1 is a first flowchart of a method for displaying desktop window provided by an embodiment of the present application;

FIG. 2 is a schematic diagram of generating a window list provided in an embodiment of the present application;

FIG. 3 is a display schematic diagram of icon display provided in an embodiment of the present application;

FIG. 4 is a display schematic diagram of a navigation bar provided in an embodiment of the present application;

FIG. 5 is a display schematic diagram of a power management provided in an embodiment of the present application;

FIG. 6 is a second flowchart of the method for displaying desktop window provided by an embodiment of the present application;

FIG. 7 is a structural diagram of a device for displaying desktop window provided in an embodiment of the present application;

FIG. 8 is a structural diagram of a terminal provided in an embodiment of the present application.

### DETAILED DESCRIPTION

In the following description, specific details such as specific system structures, technologies, etc. are provided for the purpose of illustration rather than limitation, so as to provide a thorough understanding of the embodiments of the present application. However, it should be clear to those skilled in the art that the present application may also be implemented in other embodiments without these specific details. In other cases, detailed descriptions of well-known systems, devices, circuits, and methods are omitted to prevent unnecessary details from obstructing the description of the present application.

It should be understood that when used in the specification and appended claims, the term “comprising” indicates presence of described features, integers, steps, operations, elements and/or components, but does not exclude the presence or addition of one or more other features, integers, steps, operations, elements, components and/or groups thereof.

It should also be understood that the terms used in the application specification are only for the purpose of describing specific embodiments and are not intended to limit the application. As used in the application specification and the appended claims, unless the context clearly indicates otherwise, the singular forms “a”, “an” and “the” are intended to include plural forms.

It should be further understood that the term “and/or” used in the specification and appended claims refers to any combination and all possible combinations of one or more of the associated listed items, and includes these combinations.

As used in the specification and the appended claims, the term “if” may be interpreted as “when” or “upon” or “in response to determining” or “in response to detecting” depending on the context. Similarly, the phrases “if it is determined” or “if [described condition or event] is detected” may be interpreted as meaning “upon determination” or “in response to determining” or “upon detection of [described condition or event]” or “in response to detecting [described condition or event] ” depending on the context.

In a specific implementation, the terminal described in the embodiments of the present application includes, but is not limited to, other portable devices such as mobile phones, laptop computers, or tablet computers with touch-sensitive surfaces (e.g., touch screen displays and/or touch pads). It should also be understood that in some embodiments, the device is not a portable communication device, but a desktop computer with a touch-sensitive surface (e.g., touch screen displays and/or touch pads).

In the following discussion, a terminal including a display and a touch-sensitive surface is described. However, it should be understood that the terminal may include one or more other physical user interface devices such as a physical keyboard, mouse and/or joystick.

The terminal supports various applications, such as one or more of the following: a drawing application, a presentation application, a word processing application, a website creation application, a disk burning application, a spreadsheet application, a game application, a telephone application, a video conferencing application, an email application, an instant messaging application, a workout support application, a photo management application, a digital camera application, a digital camcorder application, a web browsing application, a digital music player application, and/or a digital video player application.

Various applications that can be executed on the terminal can use at least one common physical user interface device such as a touch-sensitive surface. One or more functions of the touch-sensitive surface and corresponding information displayed on the terminal can be adjusted and/or changed between applications and/or within corresponding applications. In this way, the common physical architecture of the terminal (e.g., the touch-sensitive surface) can support various applications with user interfaces that are intuitive and transparent to the user.

It should be understood that the size of the serial numbers of the steps in the embodiment does not mean the order of execution. The execution order of each process should be determined by its function and internal logic, and should not constitute any limitation on the implementation process of the embodiment of the present application.

In order to illustrate the technical solution described in the application, a specific embodiment is provided below for illustration.

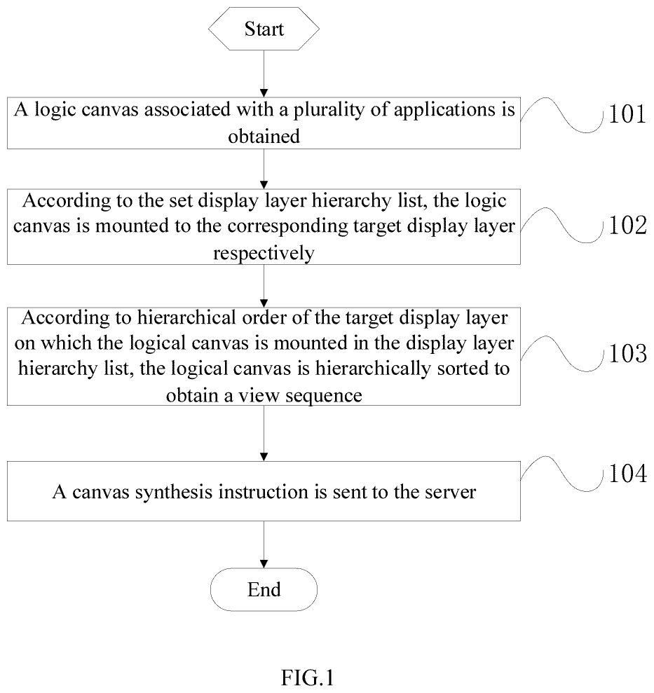

Referring to FIG. 1, FIG. 1 is a flowchart of a method for displaying desktop window provided by an embodiment of the present application. As shown in FIG. 1, the method includes the following steps.

Step 101: a logic canvas associated with a plurality of applications is obtained.

The logical canvas is laid out with the views to be displayed corresponding to the applications.

The logical canvas is specifically a logical virtual canvas. Application views that need to be displayed can be laid out on different logical canvases. The view includes, for example, an application icon, a display interface, a virtual touch button, etc.

By means of the association relationship between the logic canvas and the applications, the views to be displayed corresponding to different applications are laid out on the logic canvas, so that the views can be integrated based on the logic canvas in the subsequent processing.

In one embodiment, obtaining the logic canvas associated with the plurality of applications includes:
monitoring an installation directory of the plurality of applications;
in response that a structural change of the installation directory is detected, updating a first logic canvas associated with a first application by adding an icon of a target application to the first logic canvas or by removing the icon of the target application from the first logic canvas according to a deletion of the first application corresponding to the structural change.

This process monitors the structure changes of the installation directory corresponding to installation or uninstallation of the application program, so as to add or delete the application program icon in the corresponding logic canvas.

In an optional implementation, based on the addition or deletion of a first application corresponding to the structural change, updating the first logic canvas associated with the first application includes:
if the addition or deletion of the target application corresponding to the structural change is a creation operation of the target application, determining a display icon corresponding to the target application;
assigning icon display coordinates to display icon;
adding the display icon in the first logic canvas associated with the target application according to the icon display coordinates.

In one embodiment, the method involves front-end desktop display design.

The Linux desktop management system needs to support multi-application display. In order to avoid conflicts in the use of Linux video memory Framebuffer, in the embodiment of the present application, each application draws its own view to be displayed, and then a component integrates and displays the views. What meets the requirements is a C/S structured GUI framework, where a client is responsible for adjusting and drawing its own view, and then a server renders and synthesizes the view for display.

In the embodiment of the present application, in a specific implementation process, the GUI framework based on the Linux open source C/S structure includes Wayland, etc. Wayland removes some unnecessary intermediate layers and is better adapted to mobile devices.

Wayland is a communication protocol between a display server (Wayland compositor) and the client, and the weston is the reference implementation of the Wayland compositor.

The desktop is a special client of the weston. When implemented, the following system layers can be used.

Wherein, Lock layer is mainly used for lock screen display, and Full Screen Layer is a layer displayed after the application is full screen, and Panel layer is a title bar display layer, and Workspace layer is a layer displayed by ordinary applications, and Bottom ui layer is a display layer of an App icon, and Background layer is a background image display layer.

In the embodiment of the present application, based on the above default system layer, three layers are further extended, namely, the ask_manager layer is used to display a running application queue, and the navigation layer is used to display the system navigation button, and the power_off_ui layer is the layer used to display the power shutdown interface.

The desktop can be divided into four main modules according to its functions: application management module, task management module, system navigation module, and power management module.

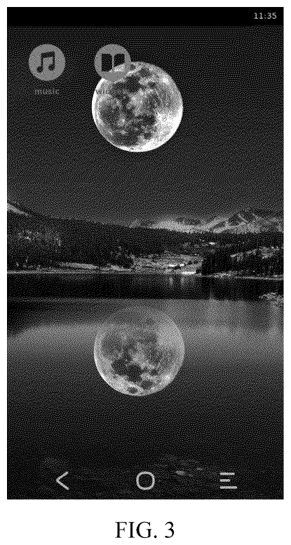

In one embodiment, in the application management module, in order to realize application management, combined with FIG. 3, it mainly provides an interactive interface for displaying currently installed applications. Specifically, it can display icons corresponding to applications by layers, and associate callback functions in icons, and control the startup and exit of applications by icons.

In the above process, the desktop extends the wayland protocol of weston_desktop according to the application management function. When the desktop is started and initialized, a new Set_app (output, surface) protocol request is added to allocate a logical canvas and bind it to the Bottom UI layer. This is to realize the function of displaying the application in the layer. Because there are many layers, the application needs to be bound to the layer to determine which layer it is displayed on to ensure normal display. The function of Set_app is mainly used to allocate a logical canvas and initialize which layer the logical canvas is displayed on.

An application program package mainly includes: App info file, application executable file, and icon. The App info file is used to record names and paths of executable files and icons.

The desktop uses the inotify mechanism (a mechanism used by the Linux kernel to notify user space file system changes) to monitor the App installation directory. Once the App installation directory structure changes, that is, an application is installed or uninstalled, the desktop will receive an event notification and perform corresponding actions according to the event type.

The event is, for example:
CREATE event: according to an App info file, creating an App object, and recording the executable file and icon file names, and allocating icon display coordinates, and binding the touch screen callback function, and drawing the icon on the previously allocated logical canvas according to the icon display coordinates, and notifying the server to re-synthesize the display.
DELETE event: according to the name parameter of the event, finding the corresponding App object to delete and redrawing the logical canvas.

When the arranged icon is finally clicked later, the weston sends a touch screen event to the desktop. The desktop finds the corresponding App object according to the icon display coordinate parameters of the touch screen event, calls the touch screen callback bound in the early stage, and starts the App.

That is, in the above process, the client sends a request to the display server, requesting to allocate the logical canvas, and the display server allocates the logical canvas and binds the bottom ui layer, and the client monitors the App installation directory by the operating system's inotify mechanism. If the App installation directory structure changes, the operating system notifies the client. The client finds the corresponding icon according to the newly added installation file directory and draws the icon on the canvas. After the client finishes drawing, it notifies the display server, which synthesizes the icons layer by layer and displays the synthesis results on the display.

In another optional embodiment, obtaining the logic canvas associated with the plurality of applications includes:
creating a task object corresponding to each of running second applications, and allocating a shared buffer to each of task objects;
obtaining current display screen frame of each of the second applications;
filling the current display screen frame into the corresponding shared buffer to obtain a second logical canvas including the shared buffer.

In one embodiment, the task objects are, for example, various window views, such as a login window, a main interface display window, a dialog window, and the like.

When there are multiple running second applications, each of the running second applications corresponds to its own task object, and a shared buffer needs to be allocated to each of the task objects, and all shared buffers correspond to the same logical canvas.

Each shared buffer is used to fill the current display screen frame of the corresponding second application, and all shared buffers are included in the same logical canvas.

The shared buffer is a view frame buffer coexisting in the same logical canvas, so that the current display screen frames corresponding to the running second applications can be arranged in the same canvas by multiple shared buffers.

The above process corresponds to the task management module function of the desktop. In one embodiment, the task management module is mainly used to visualize the running applications, and switch the applications, and terminate the applications.

In the above process, the desktop adds a new Wayland protocol interface according to the application management function. The newly added Wayland protocol interface specifically includes the following contents.

Set_task_manager_surface is used to allocate a logical canvas and bind it to the task_manager layer. The canvas is used to display the window views of each of applications.

By task_startup, the weston is used to notify the desktop that the application has started. After receiving the event, the desktop will create task objects and allocate the logical canvas and a buffer shared by the weston to each of the task objects. And the buffer is subsequently used to fill the current display frame of the application.

By task_exit, the weston is used to notify the desktop that the application has terminated. After the desktop receives the event, it will release the allocated resources.

Get_task_surface_content is used to obtain the current display frame of each application and fill it in the shared buffer allocated in the early stage.

Show_task_views links the task_manager layer to a compositor list and visualizes the running applications.

Hide_task_views removes the task_manager layer from the compositor list.

By task_views_move, multiple application views start an interactive interface movement, and when used with active_task, the application switching function can be realized.

In one embodiment, each task object corresponds to a view window, but one screen cannot accommodate the windows corresponding to all task objects, so the task object view needs to be moved. Task_views_move is used to realize a movement of the interactive interface. A mobile task object view is used to select the task object. Clicking the task object window will trigger the corresponding event, and active_task will be called to send a request to the weston. After receiving the request, the weston will find the corresponding application according to the pid (process identifier) parameter carried in the request, and restore the application to the foreground display to realize the application switching function.

Active_task, restore the application corresponding to pid to display and enable interaction.

From the general process, when the user clicks a menu key for the first time, the event callback is triggered, and esktop obtains the current display frame of each of applications by calling get_task_surface_content. Then it redraws the logical canvas according to the data of each frame, and finally notifies the weston to display the multi-application views by show_task_views.

When the user drags the multi-application view, task_views_move will be triggered, and the multi-application view will start an interactive interface movement. The weston will receive touch motion events reported by the driver one after another, and adjust the coordinates of each application view according to the event coordinates, so as to achieve the drag effect. When the drag ends and is lifted, the weston will receive a touch up event reported by the driver. At this time, a timer will be started, and the coordinates will be adjusted every certain period of time according to source coordinates and destination coordinates, until each view locates in the destination coordinates, so as to achieve the sliding effect.

When directly clicking on an application window view, the desktop event callback will be triggered, and active_task will be called to restore the application to display.

When clicking the menu key again, hide_task_views will be triggered, and the display of the multi-application view will be canceled, and the desktop will be returned.

Furthermore, in yet another different embodiment, obtaining of the plurality of logic canvases associated with the applications includes:
determining a function icon corresponding to each function key in a third application, wherein the function key includes a navigation function key or a power key;
drawing the function icon in the logic canvas corresponding to the third application to obtain a third logic canvas.

Among them, the above processing steps can correspond to the system navigation function in a specific embodiment.

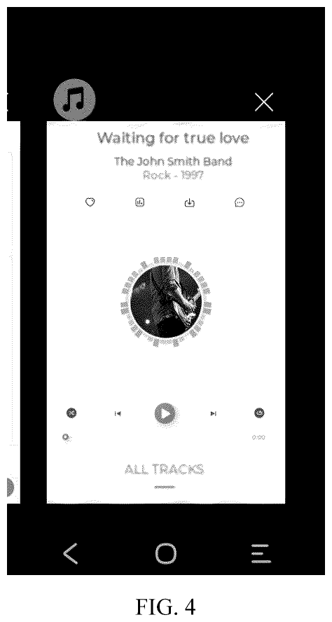

As shown in FIG. 4, a system navigation bar can be set in a user interface, which mainly consists of three buttons: a return key, a HOME key, and a menu key. The return key is mainly used to return to a previous operation of the application, and the application needs to respond to a key value of the return key. The HOME key is used to hide an application display and return to a main interface. The menu key is used to display the applications running in the background.

In the above process, the desktop extends the wayland protocol of western_desktop according to the system navigation function and adds a navigation protocol interface. The newly added navigation protocol interface includes the following contents.

Set_navigation_bar is used to allocate a logical canvas and bind the logical canvas to the navigation layer. The canvas is used to draw the back button, the HOME key, and the menu key. These three navigation buttons are bound to corresponding touch screen event callbacks.

Key_home sends a request to the weston, which is an event callback of the HOME key. After the weston receives the request, it removes all application views from the workspace layer. Finally, when the weston synthesizes, all application views are not displayed.

Key_cancel is the event callback of the return key. When the return key is clicked, the corresponding event callback will be triggered and a request will be sent to the weston. After receiving the request, the weston will find corresponding view window and send the key event of the Key_cancel to the application client corresponding to the window.

Specifically, during the implementation of the above function, the key is on the desktop, and the key event will first be passed from the weston to the desktop. The desktop then sends a Key_cancel request to the weston. The weston receives the request and finds corresponding application currently running in the foreground, and passes the request to the application currently running in the foreground and sends corresponding key event to the application.

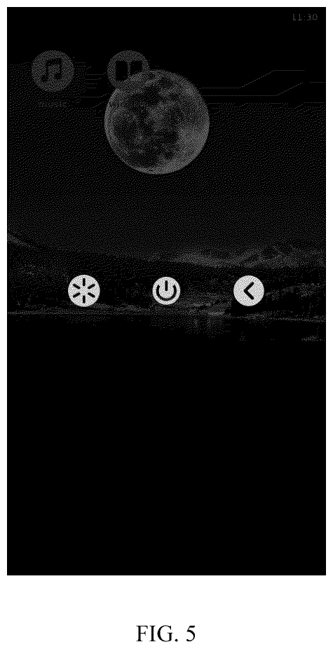

The above processing steps may correspond to a power management function in another embodiment. As shown in FIG. 5, the power management mainly provides an interactive interface for controlling the shutdown and restart of the machine.

In the above process, according to the power management function, the desktop extends the wayland protocol of western_desktop and adds a power management interface. The newly added navigation protocol interface includes the following contents.

Set_poweroff_ui is used to allocate a logical canvas and bind it to the poweroff ui layer. The canvas is used to draw shutdown, restart, and return icons, and each icon is bound to its own event callback.

Active_poweroff_ui links the poweroff ui layer into a compositor list and displays the power management interactive interface.

Deactive_poweroff_ui removes the poweroff ui layer from the compositor list.

When the power key is long pressed, the desktop detects an event reported by the driver and calls active_poweroff_ui to display the power management interactive interface. When the shutdown icon is clicked, the shutdown event callback is triggered, and the desktop directly calls reboot(RB_POWER_OFF) to shut down the machine. When the restart icon is clicked, the desktop calls reboot(RB_AUTOBOOT) to restart the machine. When the return icon is clicked, deactive poweroff_ui is called to hide the power management interactive interface.

In the above process, the communication protocol between the GUI server and the client is based on mature Wayland protocol, with the addition of multi-application switching, system navigation key interaction and power management protocols. The widely used and mature GUI Server Weston is selected to implement the Android Desktop-like and multi-application dynamic switching functions.

Step 102: according to setting display layer hierarchy list, the logic canvas is mounted to the corresponding target display layer respectively.

The hierarchical order of the target display layers of the logical canvas in the display layer hierarchy list is positively correlated with a display priority of the to-be-displayed view corresponding to the application laid out in the logical canvas.

Mounting means connecting the directory in the device file to a directory under the Linux root directory. Accessing the directory is equivalent to accessing the device file. In the step, the logical canvas is mounted to the corresponding target display layer. Specifically, the logical canvas directory is connected to the directory of the target display layer under the Linux root directory. Accessing the target display layer is equivalent to accessing the logical canvas.

From the perspective of an internal system, the weston is mainly divided into several modules: window management (shell), compositor and input management.

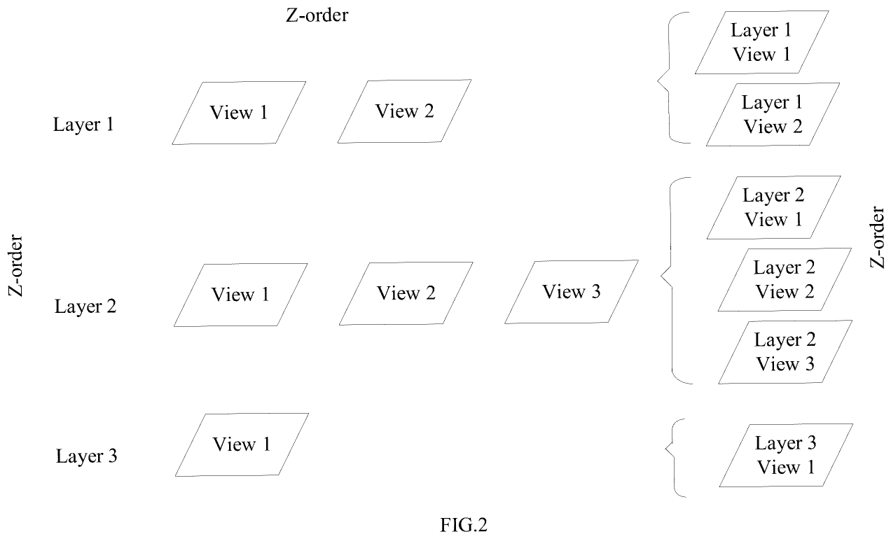

From the general process, an input management module transmits the input event to the client (APP) corresponding to the window at the top of the window stack or the currently running window. After receiving the input event, the client will take corresponding actions, such as adjusting the view position and redrawing. As shown in FIG. 2, if a redraw occurs, after the new view content buffer in each layer (the multiple views contained in Layer 1-3 on the left side of FIG. 2) is rendered, and the client transmits the new content buffer to the server, and then the server generates a window list (on the right side of FIG. 2), and then the server synthesizes the canvas corresponding to the window and finally outputs it to the framebuffer (frame buffer). The logical canvas of each layer is drawn in the video memory.

The display layers in the display layer hierarchy list include, for example, from top to bottom:
Fade Layer (fading layer, fading, gradually disappearing); Lock layer (lock layer, used to display lock screen wallpaper, etc.); Cursor layer (cursor layer, used to display the mouse); Input panel layer (input panel layer, used to display the system keyboard); FullScreen layer (full screen layer); Panel layer (used to display the title bar); Workspace layer (workspace layer, used to display applications); Background layer(background layer, used to display the desktop background).

Step 103: according to hierarchical order of the target display layer on which the logical canvas is mounted in the display layer hierarchy list, the logical canvas is hierarchically sorted to obtain a view sequence.

Step 104: a canvas synthesis instruction is sent to the server.

The canvas synthesis instruction instructs the server to synthesize and display the logical canvas according to the view sequence.

The above layers are linked into the compositor layer list. Each time a composite is to be created, the views of the layers in the compositor layer list are first merged into a view list in order. In this way, the compositor only needs to access this view list during the view composition process.

In the process, the front-end desktop determines the content of the logical canvas, and finally notifies the server to render and synthesize the logical canvas for display.

In one embodiment of the present application, by obtaining the logical canvas associated with the plurality of applications and having layouts of views to be displayed corresponding to the applications, and based on the setting display layer hierarchy list, the logical canvases are respectively mounted in the corresponding target display layers; and based on the hierarchical order of the target display layers on which the logical canvases are mounted in the display layer hierarchy list, the logical canvases are hierarchically sorted to obtain the view sequence, and a canvas synthesis instruction is sent to the server to instruct the server to synthesize and display the logical canvas based on the view sequence. The process can determine the display order of different display layers and finally synthesize the display based on the hierarchical order of the display layers in the display layer hierarchy list and the logical canvas on which the views to be displayed are arranged, for the views to be displayed corresponding to different applications, so as to realize display management and dynamic switching of desktop views based on different applications and meet interface application requirements.

The embodiments of the present application also provide different embodiments of the desktop window display method.

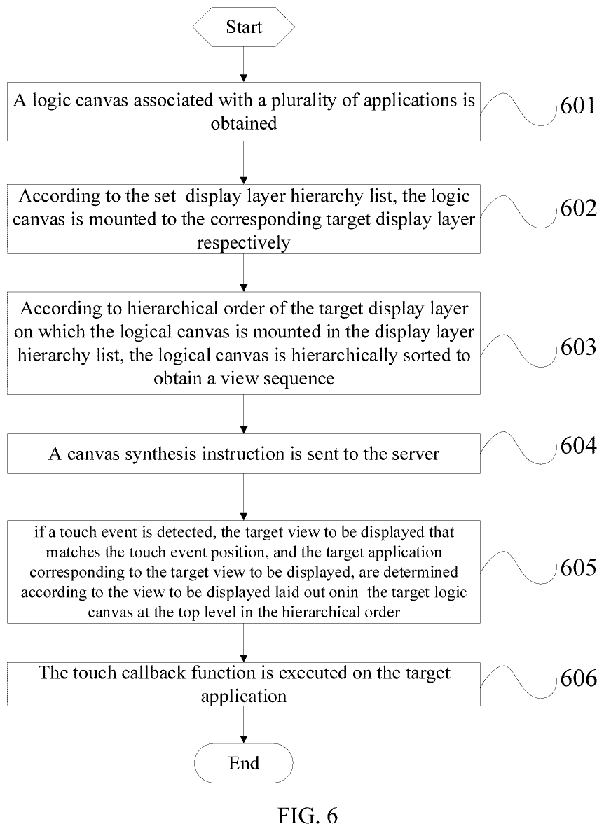

Referring to FIG. 6, FIG. 6 is a flowchart of a second method for displaying desktop window provided in an embodiment of the present application. As shown in FIG. 6, the method includes the following steps.

Step 601: a logic canvas associated with a plurality of applications is obtained.

The logical canvas is laid out with views to be displayed corresponding to the applications.

The implementation process of this step is the same as the implementation process of step 101 in the aforementioned embodiment, and will not be repeated here.

Step 602, according to setting display layer hierarchy list, the logic canvas is mounted to the corresponding target display layer respectively.

The implementation process of this step is the same as the implementation process of step 102 in the aforementioned embodiment, and will not be repeated here.

Step 603, according to hierarchical order of the target display layer on which the logical canvas is mounted in the display layer hierarchy list, the logical canvas is hierarchically sorted to obtain a view sequence.

The implementation process of this step is the same as the implementation process of step 103 in the aforementioned embodiment, and will not be repeated here.

Step 604: a canvas synthesis instruction is sent to the server.

The canvas synthesis instruction instructs the server to synthesize and display the logical canvas according to the view sequence.

The implementation process of this step is the same as the implementation process of step 104 in the aforementioned embodiment, and will not be repeated here.

Optionally, the view to be displayed laid out in the logic canvas is associated with a touch callback function; correspondingly, the method further includes following steps.

Step 605, if a touch event is detected, the target view to be displayed that matches the touch event position, and the target application corresponding to the target view to be displayed, are determined according to the view to be displayed laid out on the target logic canvas at the top level in the hierarchical order.

Step 606: the touch callback function is executed on the target application.

The touch callback function includes:
a callback function for executing a power on or a power off control; or a callback function for executing a navigation control of view return, main interface display or menu display; or a callback function for executing a display control of a running application.

In one embodiment of the present application, by obtaining the logical canvas associated with the plurality of applications and having layouts of views to be displayed corresponding to the applications, and based on the setting display layer hierarchy list, the logical canvases are respectively mounted in the corresponding target display layers; and based on the hierarchical order of the target display layers on which the logical canvases are mounted in the display layer hierarchy list, the logical canvases are hierarchically sorted to obtain the view sequence, and a canvas synthesis instruction is sent to the server to instruct the server to synthesize and display the logical canvas based on the view sequence. The process can determine the display order of different display layers and finally synthesize based on the hierarchical order of the display layers in the display layer hierarchy list and the logical canvas on which the views to be displayed are arranged, for the views to be displayed corresponding to different applications, so as to realize display management and dynamic switching of desktop views based on different applications, and further based on the display view in the synthesized display interface, in response to a touch event, a touch callback function corresponding to the target application is executed to meet the interface display and control requirements.

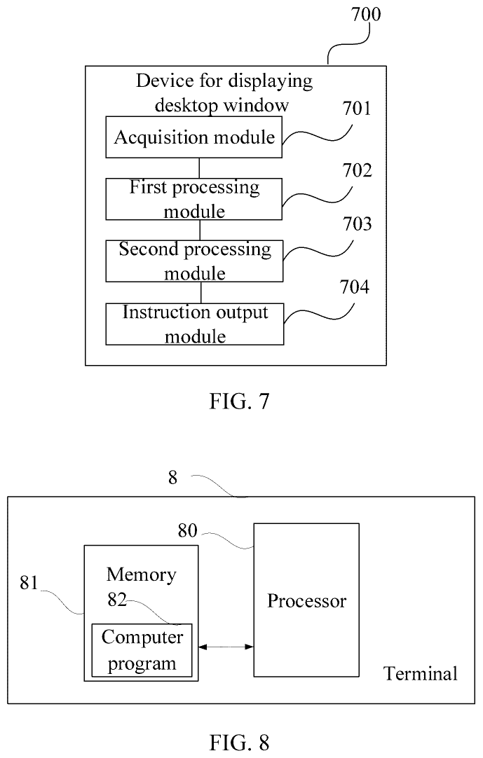

Referring to FIG. 7, which is a structural diagram of a device for displaying desktop window provided in an embodiment of the present application. For ease of description, only the part related to the embodiment of the present application is shown.

The device 700 for displaying desktop window includes:
an acquisition module 701, is used to obtain a logic canvas associated with a plurality of applications, wherein the logic canvas is laid out with views to be displayed corresponding to the applications;
a first processing module 702, is used to respectively mount the logic canvas to the corresponding target display layer according to the setting display layer hierarchy list;
a second processing module 703. is used to hierarchically sort the logical canvas according to the hierarchical order of the target display layer mounted with the logical canvas in the display layer hierarchy list to obtain a view sequence;
an instruction output module 704, is used to send a canvas synthesis instruction to the server, wherein the canvas synthesis instruction instructs the server to synthesize and display the logical canvas according to the view sequence.

The acquisition module 701 is specifically used to:
monitor the installation directory of the application;
in response that a structural change of the installation directory is detected, update a first logic canvas associated with a first application by adding an icon of a target application to the first logic canvas or by removing the icon of the target application from the first logic canvas according to a deletion of the first application corresponding to the structural change.

The acquisition module 701 is more specifically used to:
if the addition or deletion of the target application corresponding to the structural change is a creation operation of the target application, determine a display icon corresponding to the target application;
assign icon display coordinates to the display icon;
add the display icon in the first logic canvas associated with the target application according to the icon display coordinates.

The acquisition module 701 is specifically used to:
create a task object corresponding to each of running second applications, and allocating a shared buffer to each of the task objects;
obtain current display screen frame of each of the second applications;
fill the current displayed screen frame into the corresponding shared buffer to obtain a second logical canvas including the shared buffer.

The acquisition module 701 is specifically used to:
determine a function icon corresponding to each function key in the third application, wherein the function key includes a navigation function key or a power key;
drawing the function icon in the logic canvas corresponding to the third application to obtain a third logic canvas.

The view to be displayed, which is arranged in the logic canvas, is associated with a touch callback function; and the device further includes:
a touch response module, is used to determine, if a touch event is detected, a target view to be displayed that matches the position of the touch event and a target application corresponding to the target view to be displayed according to the view to be displayed that is laid out on the target logic canvas at the top level in the hierarchical order; and
execute the touch callback function on the target application.

In one embodiment, the touch callback function includes:
a callback function for executing a power on or a power off control; or,
a callback function for executing a navigation control, which is used for view return, main interface display, or menu display; or,
a callback function for executing a display control of the running application.

The device for displaying desktop window provided in the embodiment of the present application can implement each process of the embodiment of the above-mentioned method for displaying desktop window and can achieve the same technical effect. To avoid repetition, it will not be described here.

FIG. 8 is a structural diagram of a terminal provided in an embodiment of the present application. As shown in the FIG. 8, the terminal 8 of the embodiment includes: at least one processor 80 (only one processor is shown in FIG. 8), a memory 81, and a computer program 82 stored in the memory 81 and executable on the at least one processor 80, and the processor 80 implements the steps in any of the above-mentioned method embodiments when executing the computer program 82.

The terminal 8 may be a computing device such as a desktop computer, a notebook, a PDA, and a cloud server. The terminal 8 may include, but is not limited to, a processor 80 and a memory 81. Those skilled in the art will appreciate that FIG. 8 is merely an example of the terminal 8 and does not constitute a limitation on the terminal 8. The terminal 8 may include more or fewer components than shown in the figure, or may combine certain components, or different components. For example, the terminal may also include input and output devices, network access devices, buses, etc.

The processor 80 may be a central processing unit (CPU), or other general-purpose processors, digital signal processors (DSP), application-specific integrated circuits (ASIC), field-programmable gate arrays (FPGA) or other programmable logic devices, discrete gate or transistor logic devices, discrete hardware components, etc. A general-purpose processor may be a microprocessor or any conventional processor, etc.

The memory 81 may be an internal storage unit of the terminal 8, such as a hard disk or memory of the terminal 8. The memory 81 may also be an external storage device of the terminal 8, such as a plug-in hard disk, a smart media card (SMC), a secure digital (SD) card, a flash card, etc., equipped on the terminal 8. Further, the memory 81 may include both an internal storage unit of the terminal 8 and an external storage device. The memory 81 is used to store the computer program and other programs and data required by the terminal. The memory 81 may also be used to temporarily store data that has been output or is to be output.

The technicians in the relevant field can clearly understand that for the convenience and simplicity of description, only the division of the above-mentioned functional units and modules is used as an example for illustration. In practical applications, the above-mentioned function allocation can be completed by different functional units and modules as needed, that is, the internal structure of the device can be divided into different functional units or modules to complete all or part of the functions described above. The functional units and modules in the embodiment can be integrated in a processing unit, or each unit can exist physically separately, or two or more units can be integrated in one unit. The above-mentioned integrated unit can be implemented in the form of hardware or in the form of software functional units. In addition, the specific names of the functional units and modules are only for the convenience of distinguishing each other, and are not used to limit the scope of protection of this application. The specific working process of the units and modules in the above-mentioned system can refer to the corresponding process in the aforementioned method embodiment, which will not be repeated here.

In the above embodiments, the description of each embodiment has its own emphasis. For parts that are not described or recorded in detail in a certain embodiment, reference can be made to the relevant descriptions of other embodiments.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of the application.

In the embodiments provided in the present application, it should be understood that the disclosed devices/terminals and methods can be implemented in other ways. For example, the device/terminal embodiments described above are only schematic. For example, the division of the modules or units is only a logical function division. There may be other division methods in actual implementation, such as multiple units or components can be combined or integrated into another system, or some features can be ignored or not executed. Another point is that the mutual coupling or direct coupling or communication connection shown or discussed can be through some interfaces, indirect coupling or communication connection of devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solution of this embodiment.

In addition, each functional unit in each embodiment of the present application may be integrated into one processing unit, or each unit may exist physically separately, or two or more units may be integrated into one unit. The above-mentioned integrated unit may be implemented in the form of hardware or in the form of software functional units.

If the integrated module/unit is implemented in the form of a software functional unit and sold or used as an independent product, it can be stored in a computer-readable storage medium. Based on this understanding, the present application implements all or part of the processes in the above-mentioned embodiment method, and can also be completed by instructing the relevant hardware by a computer program. The computer program can be stored in a computer-readable storage medium. When the computer program is executed by the processor, the steps of the above-mentioned various method embodiments can be implemented. Among them, the computer program includes computer program code, and the computer program code can be in source code form, object code form, executable file or some intermediate form. The computer-readable medium may include: any entity or device capable of carrying the computer program code, recording medium, U disk, mobile hard disk, magnetic disk, optical disk, computer memory, read-only memory (ROM, Read-Only Memory), random access memory (RAM, Random Access Memory), electric carrier signal, telecommunication signal and software distribution medium. It should be noted that the content contained in the computer-readable medium can be appropriately increased or decreased according to the requirements of legislation and patent practice in the jurisdiction. For example, in some jurisdictions, according to legislation and patent practice, computer-readable media do not include electric carrier signals and telecommunication signals.

The present application implements all or part of the processes in the above-mentioned embodiment method, and may also be implemented through a computer program product. When the computer program product runs on a terminal, the terminal can implement the steps in the above-mentioned method embodiments when executing the computer program product.

The embodiments described above are only used to illustrate the technical solutions of the present application, rather than to limit them. Although the present application has been described in detail with reference to the aforementioned embodiments, a person skilled in the art should understand that the technical solutions described in the aforementioned embodiments may still be modified, or some of the technical features may be replaced by equivalents. Such modifications or replacements do not deviate the essence of the corresponding technical solutions from the spirit and scope of the technical solutions of the embodiments of the present application, and should all be included in the protection scope of the present application.

1. A method for displaying desktop window, comprising:
obtaining a logic canvas associated with a plurality of applications, the logic canvas being laid out with views to be displayed corresponding to the plurality of applications;
mounting the logic canvas to a corresponding target display layer by setting a display layer hierarchy list;
according to a hierarchical order of the target display layer on which the logical canvas is mounted in the display layer hierarchy list, obtaining a view sequence by hierarchically sorting the logical canvas;
sending a canvas synthesis instruction to a server, and instructing the server to synthesize and display the logical canvas according to the view sequence by using the canvas synthesis instruction.

2. The method according to claim 1, wherein obtaining the logic canvas associated with the plurality of applications comprises:
monitoring an installation directory of the plurality of applications;
in response that a structural change of the installation directory is detected, updating a first logic canvas associated with a first application by adding an icon of a target application to the first logic canvas according to an addition of the first application corresponding to the structural change, or by removing the icon of the target application from the first logic canvas according to a deletion of the first application corresponding to the structural change.

3. The method according to claim 2, wherein updating the first logic canvas associated with the first application according to the addition or the deletion of the first application corresponding to the structural change, comprises:
in responses that the addition or deletion of the target application corresponding to the structural change is a creation operation of the target application, determining a display icon corresponding to the target application;
assigning icon display coordinates to the display icon;
adding the display icon in the first logic canvas associated with the target application according to the icon display coordinates.

4. The method according to claim 1, wherein obtaining the logic canvas associated with the plurality of applications comprises:
creating a task object corresponding to each of running second applications, and allocating a shared buffer to each of task objects;
obtaining a current display screen frame of each of the second applications;
obtaining a second logical canvas comprising the shared buffer by filling the current displayed screen frame into corresponding shared buffer.

5. The method according to claim 1, wherein obtaining the logic canvas associated with the plurality of applications comprises:
determining a function icon corresponding to each of function keys in a third application, wherein the function keys comprise a navigation function key or a power key;
obtaining a third logic canvas by drawing the function icon in the logic canvas corresponding to the third application.

6. The method according to claim 1, wherein the view to be displayed in the logical canvas is associated with a touch callback function; after sending the canvas synthesis instruction to the server, the method further comprises:
in responses that a touch event is detected, determining a target view to be displayed that matches a position of the touch event and a target application corresponding to the target view to be displayed, according to the target view to be displayed that is laid out on the target logic canvas at a top level in the hierarchical order;
executing the touch callback function on the target application.

7. The method according to claim 6, wherein the touch callback function comprises:
a callback function for executing a power on control or a power off control; or, a callback function for executing a navigation control, which is used for executing a view return, a main interface display, or a menu display; or, a callback function for executing a display control of the running application.

8-10. (canceled)

11. A terminal comprising:
a processor; and
a non-transitory storage medium coupled to the processor and configured to store a plurality of instructions, which cause the processor to:
obtain a logic canvas associated with a plurality of applications, the logic canvas being laid out with views to be displayed corresponding to the plurality of applications;
mount the logic canvas to a corresponding target display layer by setting a display layer hierarchy list;
according to a hierarchical order of the target display layer on which the logical canvas is mounted in the display layer hierarchy list, obtain a view sequence by hierarchically sorting the logical canvas;
send a canvas synthesis instruction to a server, and instruct the server to synthesize and display the logical canvas according to the view sequence by using the canvas synthesis instruction.

12. The terminal according to claim 11, wherein the plurality of instructions are further configured to cause the processor to:
monitor an installation directory of the plurality of applications;
in response that a structural change of the installation directory is detected, update a first logic canvas associated with a first application by adding an icon of a target application to the first logic canvas according to an addition of the first application corresponding to the structural change, or by removing the icon of the target application-from the first logic canvas according to a deletion of the first application corresponding to the structural change.

13. The terminal according to claim 12, wherein the plurality of instructions are further configured to cause the processor to:
in responses that the addition or deletion of the target application corresponding to the structural change is a creation operation of the target application, determine a display icon corresponding to the target application;
assign icon display coordinates to the display icon;
add the display icon in the first logic canvas associated with the target application according to the icon display coordinates.

14. The terminal according to claim 11, wherein the plurality of instructions are further configured to cause the processor to:
create a task object corresponding to each of running second applications, and allocate a shared buffer to each of task objects;
obtain a current display screen frame of each of the second applications;
obtain a second logical canvas comprising the shared buffer by filling the current displayed screen frame into corresponding shared buffer.

15. The terminal according to claim 11, wherein the plurality of instructions are further configured to cause the processor to:
determine a function icon corresponding to each of function keys in a third application, wherein the function keys comprise a navigation function key or a power key;
obtain a third logic canvas by drawing the function icon in the logic canvas corresponding to the third application.

16. The terminal according to claim 11, wherein the view to be displayed in the logical canvas is associated with a touch callback function; the plurality of instructions are further configured to cause the processor to:
in responses that a touch event is detected, determine a target view to be displayed that matches a position of the touch event and a target application corresponding to the target view to be displayed, according to the target view to be displayed that is laid out on the target logic canvas at a top level in the hierarchical order;
execute the touch callback function on the target application.

17. The terminal according to claim 16, wherein the touch callback function comprises:
a callback function for executing a power on control or a power off control; or,
a callback function for executing a navigation control, which is used for executing a view return, a main interface display, or a menu display; or, a callback function for executing a display control of the running application.

18. A non-transitory storage medium having stored thereon instructions that, when executed by at least one processor of a terminal, causes the least one processor to execute instructions of a method for displaying desktop window, the method comprising:
obtaining a logic canvas associated with a plurality of applications, the logic canvas being laid out with views to be displayed corresponding to the plurality of applications;
mounting the logic canvas to a corresponding target display layer by setting a display layer hierarchy list;
according to a hierarchical order of the target display layer on which the logical canvas is mounted in the display layer hierarchy list, obtaining a view sequence by hierarchically sorting the logical canvas;
sending a canvas synthesis instruction to a server, and instructing the server to synthesize and display the logical canvas according to the view sequence by using the canvas synthesis instruction.

19. The non-transitory storage medium according to claim 18, wherein obtaining the logic canvas associated with the plurality of applications comprises:
monitoring an installation directory of the plurality of applications;
in response that a structural change of the installation directory is detected, updating a first logic canvas associated with a first application by adding an icon of a target application to the first logic canvas according to an addition of the first application corresponding to the structural change, or by removing the icon of the target application from the first logic canvas according to a deletion of the first application corresponding to the structural change.

20. The non-transitory storage medium according to claim 19, wherein updating the first logic canvas associated with the first application according to the addition or the deletion of the first application corresponding to the structural change, comprises:
in responses that the addition or deletion of the target application corresponding to the structural change is a creation operation of the target application, determining a display icon corresponding to the target application;
assigning icon display coordinates to the display icon;
adding the display icon in the first logic canvas associated with the target application according to the icon display coordinates.

21. The non-transitory storage medium according to claim 18, wherein obtaining the logic canvas associated with the plurality of applications comprises:
creating a task object corresponding to each of running second applications, and allocating a shared buffer to each of task objects;
obtaining a current display screen frame of each of the second applications;
obtaining a second logical canvas comprising the shared buffer by filling the current displayed screen frame into corresponding shared buffer.

22. The non-transitory storage medium according to claim 18, wherein obtaining the logic canvas associated with the plurality of applications comprises:
determining a function icon corresponding to each of function keys in a third application, wherein the function keys comprise a navigation function key or a power key;
obtaining a third logic canvas by drawing the function icon in the logic canvas corresponding to the third application.

23. The non-transitory storage medium according to claim 18, wherein the view to be displayed in the logical canvas is associated with a touch callback function; after sending the canvas synthesis instruction to the server, the method further comprises:
in responses that a touch event is detected, determining a target view to be displayed that matches a position of the touch event and a target application corresponding to the target view to be displayed, according to the target view to be displayed that is laid out on the target logic canvas at a top level in the hierarchical order;
executing the touch callback function on the target application.
